(19) United States
(12) Patent Application Publication
(10) Pub. No.: US 2026/0340533 A1
(43) Pub. Date: Oct. 29, 2026

(54) System and Method for Managing Construction

(71) Applicant: Eric Wexler, Tampa, FL (US)

(72) Inventor: Eric Wexler, Tampa, FL (US)

(21) Appl. No.: 19/737,004

(22) Filed: Jul. 10, 2026

Related U.S. Application Data
(63) Continuation-in-part of application No. 18/652,419, filed on May 1, 2024.

(51) Int. Cl. G06Q 10/0631; G06F 16/955

(52) U.S. Cl. CPC G06Q 10/063114; G06F 16/9554

(57) ABSTRACT

A system and method for construction management includes a scannable job site code that is scanned by a camera application of a worker's device. After scanning, user interfaces are displayed on the worker's device to determine the craft of the worker and if the worker is arriving or wants to report an issue. When arriving, a set of tasks for that craft are displayed. When the worker wants to report an issue, text of the issue is captures, a craft responsible for fixing the issue is determined, a contact for the craft at the job site is determined and a notification of the issue is immediately sent to the contact.

### FIELD OF THE INVENTION

This invention relates to managing construction and more specifically, coordinating several crafts at multiple construction sites including inter-craft communications.

### BACKGROUND OF THE INVENTION

Many homes or other buildings are often built in multiples, typically a tract of buildings or homes. Some larger home builders often purchase large properties and construct roads, ponds, infrastructure, common areas, and many homes on speculation that buyers will want to live in the new community and new homes. Often 500 or more homes are constructed by such home builders in a single locale. As the home builder is able to obtain preferred pricing for materials as the home builder has more leverage through buying 500 front entry doors instead of a different builder buying just one or two, theoretically, the home builder has increased profits per home (over that of a builder constructing a single home or maybe two homes).

Offsetting this increased profit is losses due to mismanagement of the projects. There is a necessary sequence of various activities necessary to construct a building. For example, the foundation comes first, setting footing, tiles, digging basements, pouring cement or a mason installing cinder blocks. This all must be done before a carpenter can install floor joists, sub floors, interior and exterior walls, staircases, etc. This all must be done before the electrician installs electrical wires, electric panels, switch boxes, outlet boxes, etc., and before a plumber installs water pipes and drainpipes. Somewhere in the scheme of things, the carpenter must install a roof and a roofer install roofing tiles, metal, or other roof material. Windows need to be installed by a carpenter. A drywall installer will install drywall. Now the building is ready for either trim by a carpenter or painting by a painter. Railings need to be installed by a carpenter. After these are complete, the flooring is installed by an installer (e.g., rugs, vinyl, tile). Now kitchen and bathroom cabinets are installed by a carpenter, then when finished, the electricians and plumbers return to install fixtures, lights, toilets, showers, switches, outlets, etc. Finishing must be done by a carpenter, for example, doorknobs, cabinet pulls, etc. Inspections are performed after several of these tasks by an inspector.

Nowadays, coordination of all of these tasks is often automated so that any dependencies are met before the next craft is invited to visit the building to perform their required tasks. For example, dependencies are laid out and a construction manager is assigned to several projects. The construction manager often has little experience, and the software is merely scheduling software, for example, scheduling the framer to complete the sub-floors and frame before the roof is installed (roof installation may need a different team that has a crane). In the past, when the framer is finished with the framing, the framer notifies the construction manager (e.g., by phone, email, text) and the construction manager then notifies the roof installer (e.g., by phone, email, text). This process works but is inefficient for several reasons. For one, the construction manager is the weak link in the process, receiving hundreds of messages a day and needing to respond to each or to initiate next steps based upon each message. It is estimated that over 70% of the status communications at a typical job site is by phone, text, or email. For another, often there are unscheduled issues that must be addressed before the next step can begin. All of these issues are spread across phone calls, text messages, email messages, handwritten notes, etc., making it difficult for the construction manager keep track of what is going on or to perform any form of searching to find a prior message. Further, it is difficult to provide feedback to teams or individuals when the project is completed. For example, the construction manager will find it difficult to inform a subcontractor that an individual that works for that subcontractor consistently frames doors that are supposed to be 2′4″ wide at 4′2″ wide, and maybe the subcontractor can help this person at reading blueprints, etc.

An unscheduled issue is, for example, if the electrician notifies the construction manager that electrical installation is complete and the construction manager notifies the drywall installer to start and the drywall installer cannot finish one or two walls because there is a wire floating in the wall that wasn't inserted into an electrical box. If the drywall installer had put up the drywall, the intended outlet or switch will not be connected and, eventually, when someone discovers the issue, rework will be needed to retrieve the wire and insert the wire into the electrical box. Currently, there is no way for one craft (e.g., drywaller) to communicate with another craft (e.g., electrician) to inform that craft of the issue so that the building can be revisited to correct the discrepancy before the first craft completes their task without going through the weak link-the construction manager. Certainly, the first craft (e.g., drywaller) can notify the construction manager (e.g., by phone, email, text), but the busy construction manager may be buried in messages and not address the situation with the second craft (e.g., electrician) for hours, wasting time of the first craft as they cannot finish their tasks.

With today's technology and methods, in the above scenario, it is unlikely that the drywall installer knows the electrician, or which of several electricians did the electrical work on that building and, therefore, has no way to directly communicate with the correct electrician, only being able to report to the construction manager that they cannot complete their task and the reasons for so.

It should be noted that often construction managers have little training and there is often a high turnover and when a turnover occurs, much of the history and status of each project is lost.

It should also be noted that incorrect address information is often the root of many problems from the craft being at the wrong location to the craft reporting that materials are needed at the incorrect location, all causing delays in the process.

What is needed is an automated system that provides direct communications between various craft teams that are contributing to each building.

### SUMMARY OF THE INVENTION

A system for construction management has a scannable job site code. The scannable job site code is scanned by a camera application of a worker's device. After scanning, user interfaces are displayed on the worker's device to determine the craft of the worker and if the worker is arriving or wants to report an issue. When arriving, a set of tasks for that craft are displayed. When the worker wants to report an issue, text of the issue is captured, a craft responsible for fixing the issue is determined, a contact for the craft at the job site is determined and a notification of the issue is immediately sent to the contact.

In one embodiment, a system for managing construction at a job site the system is disclosed including a server computer, that has storage and a database installed within the storage. The database is populated with user data and activity data related to the construction at the job site. A worker has a smartphone that has a processor, a display, mechanisms for data entry, local storage, and a way to communicating with the server computer. There is a camera application running on the processor of the smartphone. At the job site, there is a job site code encoded into a scannable medium. After the camera application captures the job site code, the camera application initializes a browser application to run on the smartphone and the browser application connects with the server computer providing the job site code to the server computer. The server computer sends a first user interface to the browser application and the browser application displays the first user interface on the display of the smartphone; the first user interface comprises selections for a craft of the worker. When the server computer receives the selection for the craft of the worker from the browser application. the server computer sends a second user interface using the browser application and the browser application displays the second user interface on the display of the smartphone; the second user interface includes selections for when the worker is arriving at the job site or when the worker needs to report an issue. Upon receiving a response from the browser application, when the response indicates arriving at the job site, the server computer retrieves a set of activities for the craft at the job site from the database and sends the set of activities to the browser application and the browser application displays the set of activities on the display of the smartphone. When the response indicates that the worker needs to report the issue, a third user interface is sent to the browser application and upon receiving the third user interface, the third user interface is displayed on the display of the smartphone; the third user interface provides input areas for the worker to describe the issue. After the worker describes the issue, the browser application sends the issue to the server computer for analysis and upon receiving the issue, the server computer determines a responsible craft for the issue, the server computer looks up the responsible craft in the database to determine a contact for the responsible craft, and the server computer immediately transmits the issue to the contact for the responsible craft.

In another embodiment, a method for managing construction at a job site is disclosed including providing a database installed within a storage and populating the database with contacts and activity data related to the construction at the job site. A job site code encoded into a scannable medium is installed at the job site. A worker captures the job site code using a camera application of a smartphone which then initializes a browser application to run on the smartphone and the browser application connects with a server computer, providing the job site code to the server computer. The server computer sending a first user interface to the browser application and the browser application displaying the first user interface on a display of the smartphone; the first user interface comprising selections for a craft of the worker. When the server computer receives the selection for the craft of the worker from the browser application, the server computer sends a second user interface using the browser application and the browser application displaying the second user interface on the display of the smartphone; the second user interface includes selections for when the worker is arriving at the job site or when the worker needs to report an issue. Receiving a response from the browser application, when the response indicates arriving at the job site, the server computer retrieves a set of activities for the craft at the job site from the database and the server computer sends the set of activities to the browser application and the browser application displays the set of activities on the display of the smartphone. When the response indicates that the worker needs to report the issue, the server computer sends a third user interface to the browser application and upon receiving the third user interface, displays the third user interface on the display of the smartphone, the third user interface providing input areas for the worker to describe the issue. The worker describes the issue, the browser application sends the issue to the server computer for analysis and upon receiving the issue, the server computer determines a responsible craft for the issue and the server computer looks up the responsible craft in the database to determine a contact for the responsible craft and the server computer immediately transmits the issue to the contact for the responsible craft.

In another embodiment, a system for managing construction of a plurality of buildings is disclosed including a server computer that has a storage and a database installed within the storage. The database is populated with user data and activity data related to the construction of the plurality of buildings. A smartphone has a processor, a display, input device for data entry, local storage, and circuitry for communicating with the server computer. A job site code is encoded into a scannable medium that is installed at a construction site. A construction management application is installed in the local storage of the smartphone and runs on the processor of the smartphone causing the smartphone to: validate a user of the smartphone by communicating with the server computer and using the database for authentication; scan the job site code upon the user visiting the construction site; send the job site code to the server computer and retrieve an activity to be performed by the user at the construction site from the server computer; upon completion of the activity, receives a status of the activity and optional notes from the user and sends the status and the optional notes to the server computer; responsive to receiving the status and the optional notes, the server computer updates the database with the status and the optional notes and the server computer determines a next activity for the user, the server computer sends the next activity to the smartphone; and the smartphone displays the next activity on the display of the smartphone.

In another embodiment, a method for construction management includes a construction management application running on a processor of a user device scanning a job site code that is associated with a construction location. Responsive to the construction management application receiving the job site code, the construction management application sends a transaction to a server computer that includes the job site code. Responsive to receiving the transaction, software running on the server computer finds the job site code in the database of construction sites and activities and responsive to finding the job site code in the database of construction sites and activities, software running on the server computer sends an activity transaction to the user device, the activity transaction comprising an activity that is to be performed by a user of the user device. Responsive to the construction management application receiving the activity transaction, the construction management application displays the activity and options at the user device, the options including a completed-option and a partially-completed-option. When the activity is completed, a user selects one of the options to indicate completion and responsive to such, the construction management application sends the one of the options to the server computer. Responsive to receiving the one of the options, software running on the server computer updates a status of the activity based upon the one of the options, determines a next activity to be performed by the user of the user device, and sends a next-activity transaction to the construction management application on the user device, the next-activity transaction including the next activity. Responsive to receiving the next activity by the user device, the construction management application displays the next activity.

In another embodiment, program instructions tangibly embodied in a non-transitory storage medium comprising at least one instruction configured to implement a system for construction management, wherein the at least one instruction includes computer readable instructions executed by a first processor of a user device causing the user device to scan a job site code that is associated with a construction location. Responsive to the computer readable instructions executed by the first processor of the user device receiving the job site code, the computer readable instructions executed by the first processor of the user device causing the user device to send a transaction to a server computer, the server computer having a second processor and access to a database of construction sites and activities, the transaction including the job site code. Responsive to the computer readable instructions executed by the second processor of the server computer receiving the transaction, the computer readable instructions executed by the second processor finds the job site code in the database of construction sites and activities and sends an activity transaction to the user device, the activity transaction includes an activity that is to be performed by the user of the user device. Responsive to the computer readable instructions executed by the first processor of the user device receiving the activity transaction, the computer readable instructions executed by the first processor displays the activity and options at the user device, the options include a completed-option and a partially-completed-option. When the activity is completed, a user selects one of the options to indicate completion and responsive to such, the computer readable instructions executed by the first processor of the user device sends the selected option to the server computer. Responsive to receiving the selected option, the computer readable instructions executed by the second processor of the server computer updates a status of the activity based upon the selected option, determines a next activity to be performed by the user of the user device, and sends a next-activity transaction to the user device, the next-activity transaction including the next activity. Responsive to receiving the next activity by the user device, the computer readable instructions executed by the first processor of the user device displays the next activity at the user device.

### BRIEF DESCRIPTION OF DRAWINGS

The invention can be best understood by those having ordinary skill in the art by reference to the following detailed description when considered in conjunction with the accompanying drawings in which:

FIG. 1 illustrates a data connection diagram of the system for managing construction.

FIG. 2 illustrates a schematic view of a typical smartphone.

FIG. 3 illustrates a schematic view of a typical computer system such as a server computer or personal computer.

FIGS. 4-10 and 10A illustrate smartphone user interfaces of the system for managing construction.

FIGS. 11, 12, 12A, and 13 illustrate exemplary data records of the system for managing construction.

FIGS. 14, 15, 16, and 17 illustrate exemplary program flows of the system for managing construction.

FIGS. 18, 19, 20, 20A, 21, 22, and 23 illustrate smartphone user interfaces of a second embodiment of the system for managing construction.

FIGS. 24 and 25 illustrate exemplary program flows of the second embodiment of the system for managing construction.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

Throughout this description, the term job site refers to a single construction site of a home or other building. The term track refers to multiple job sites, for example, when a track of 50-100 houses is being constructed. The term, craft, refers to one or more workers that perform certain functions at a construction site. The workers often operate hand and power tools, work the earth, erect framing, install drywall, do trim work, install electrical features, install plumbing, install molding and flooring, etc. One specific craft is carpenter and, for a given job site, one or more carpenters build walls (framing), install drywall, trim, etc. It should be noted that, after the walls are built and before the drywall is installed, often electricians for a different craft must run wires and install electrical boxes for outlets and switches. When two or more workers of a particular craft work together to complete a task, this is referred to as a team.

Currently, the predominant amount of trade/craftsmen scheduling is by phone, typically called by the construction manager. For example, when the electrical trade completes rough wiring, the electrician or team leader calls or texts the construction manager to signal completion. At some time later, the construction manager calls or texts an inspector to inspect the wiring. Then, upon completion of the inspection, the inspector calls or texts the construction manager to signal completion of the inspection and any issues found. Assuming no issues were found, the construction manager calls or texts a craftsman to install drywall. In this simple example, there is definitely a time lag as the construction manager may be too busy to read a text or answer the phone, then when the construction manager does get time, the inspector might be busy on a different job or the craftsman called to install the drywall might be busy at a different site. Further, the above mechanisms do not allow for direct communication between each trade. For example, if the inspector found a wire that was not properly secured to the framing, the inspector has no ability to inform the electrician to remedy the issue and must report the issue to the construction manager and the construction manager then must contact the electrician.

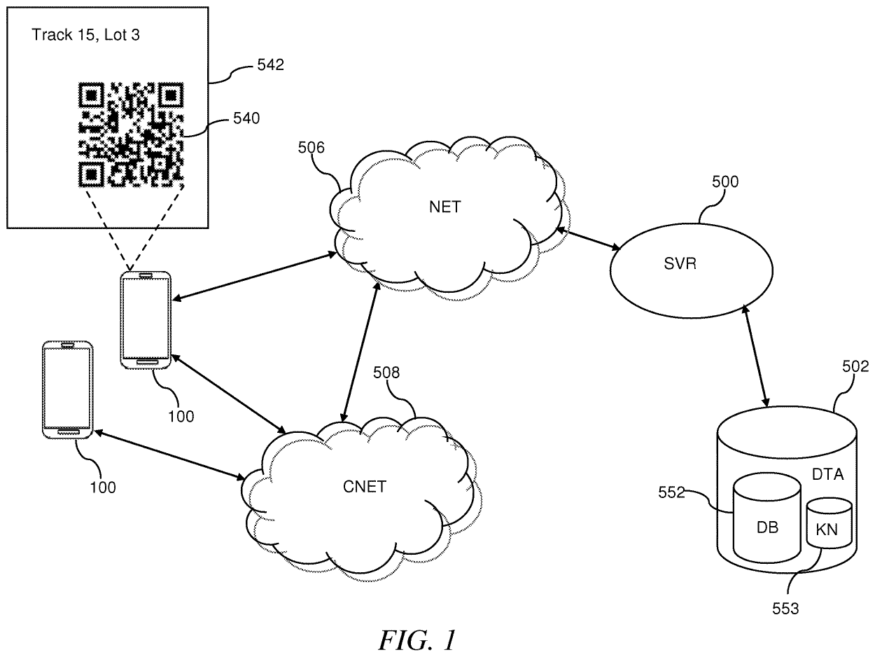

A portion of the system for managing construction operates by way of a construction management application. Each user of the construction management application uses a device upon which the construction management application is installed. Although many devices are anticipated for running the construction management application (e.g., tablet computer, notebook computer, smart watch), a smartphone 100 (see FIG. 1) is used as an example, throughout.

Referring to FIG. 1 illustrates a data connection diagram of the exemplary system for managing construction. In this example, one or more devices such as smartphones 100 communicate through the cellular network 508 and/or through a wide area network 506 (e.g. the Internet) to a server computer 500.

The server computer 500 has access to data storage 502 (e.g. “cloud” storage or local storge) that is used to store data related to each home being built and each craftsperson/team, for example, in a database 552. Further, when analyzing inputs from workers using artificial intelligence, a knowledgebase 553 is also stored within the storage 502 or any other storage location accessible by the server computer 500.

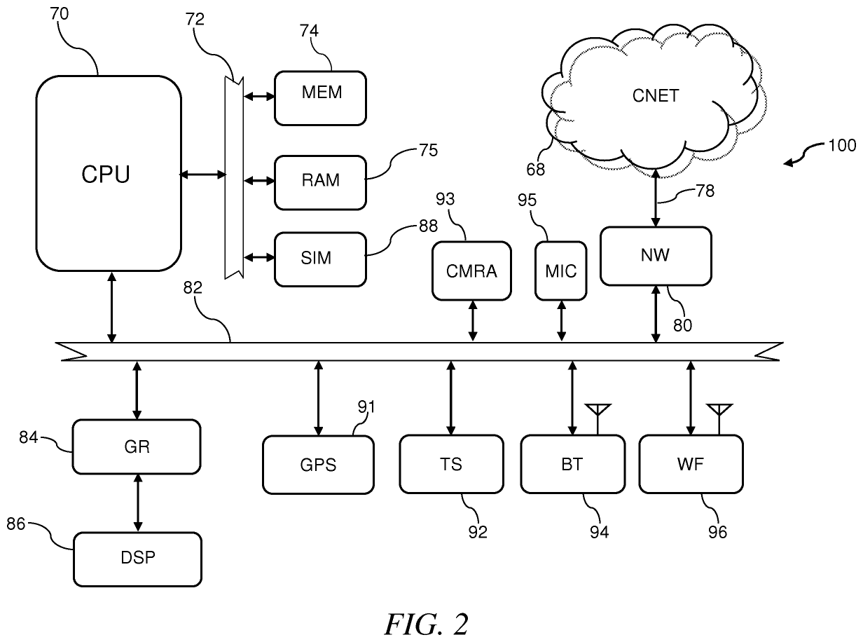

Although one path between the smartphone 100 and the server computer 500 is shown going through the cellular network 508 and the wide area network 506 as shown, any known data path is anticipated. For example, the Wi-Fi transceiver 96 (see FIG. 2) of the smartphone 100 is used to communicate directly with the wide area network 506, which includes the Internet, and, consequently, with the server computer 500.

The server computer 500 transacts with software running on the smartphone 100 through the network(s) 508/506. The software (e.g., an application) presents menus to/on the smartphone 100, provides data to the smartphone 100, and communicates information to/from the server such as job sequencing, scheduling, and issues.

The server computer 500 transacts with the construction management application running on the smartphone 100 as needed, for example, when the job site code 540 is scanned (e.g., a bar code, quick response code or QR code®, or any machine-readable coding that is posted on a plaque 542 or other common location at the job site).

In FIG. 1, an exemplary data connection diagram of the system for managing construction is shown. The system for managing construction, for example, includes a server computer 500 that transacts with one or more end user devices (e.g. smartphone 100) to manage activities related to construction of a building or house.

The system for common contact management stores scheduling information, craftsperson/team assignments, issue information in a database 552 (e.g. in data storage 502 that is local to the server computer 500, cloud-based storage, etc.).

Referring to FIG. 2, a schematic view of a typical end-user device, a smartphone 100 is shown. Although any end-user device is anticipated (e.g., tablet computer, smart watch), for clarity purposes, a smartphone 100 will be used in the remainder of the description.

The system for managing construction is described using a processor-based end-user device (e.g., smartphone 100) for providing the login and user interfaces necessary for managing construction, for example, determining which craft is needed at a particular site. The present invention is in no way limited to using a smartphone 100 and any similar device is anticipated (e.g., cellular phone, portable digital assistant, tablet, notebook, smart watch, etc.).

The example smartphone 100 represents a typical device used for accessing user interfaces of the system for managing construction. This exemplary smartphone 100 is shown in its simplest form. Different architectures are known that accomplish similar results in a similar fashion and the present invention is not limited in any way to any smartphone 100 system architecture or implementation. In this smartphone 100, a processor 70 executes or runs programs in a random-access memory 75. The programs are generally stored within a persistent memory 74 and loaded into the random-access memory 75 when needed. Also accessible by the processor 70 is a SIM card 88 (subscriber information module) having a subscriber identification and often persistent storage. The processor 70 is any processor, typically a processor designed for phones. The persistent memory 74, random access memory 75, and SIM card are connected to the processor by, for example, a memory bus 72. The random-access memory 75 is any memory suitable for connection and operation with the selected processor 70, such as SRAM, DRAM, SDRAM, RDRAM, DDR, DDR-2, etc. The persistent memory 74 is any type, configuration, capacity of memory suitable for persistently storing data, for example, flash memory, read only memory, battery-backed memory, etc. In some exemplary smartphones 10, the persistent memory 74 is removable, in the form of a memory card of appropriate format such as SD (secure digital) cards, micro-SD cards, compact flash, etc.

Also connected to the processor 70 is a system bus 82 for connecting to peripheral subsystems such as a cellular network interface 80, a graphics adapter 84 and a touch screen interface 92. The graphics adapter 84 receives commands from the processor 70 and controls what is depicted on the display 86. The touch screen interface 92 provides navigation and selection features.

In general, some portions of the persistent memory 74 and/or the SIM card 88 is used to store programs, executable code, and data, etc. In some embodiments, other data is stored in the persistent memory 74 such as audio files, video files, text messages, etc.

The peripherals are examples and other devices are known in the industry such as Global Positioning Subsystem 91, speakers, microphones, USB interfaces, camera 93, microphone 95, Bluetooth transceiver 94, Wi-Fi transceiver 96, image sensors, temperature sensors, etc., the details of which are not shown for brevity and clarity reasons.

The cellular network interface 80 connects the smartphone 10 to the cellular network 68 through any cellular band and cellular protocol such as GSM, TDMA, LTE, 5G, etc., through a wireless medium 78. There is no limitation on the type of cellular connection used. The cellular network interface 80 provides voice calls, data, and messaging services to the smartphone 100 through the cellular network 68.

For local communications, many smartphones 100 include a Bluetooth transceiver 94, a Wi-Fi transceiver 96, near-field transceivers, or any combination of such. Such features of a smartphone 100 provides data communications between the smartphone 100 and data access points and/or other computers such as a personal computer (not shown).

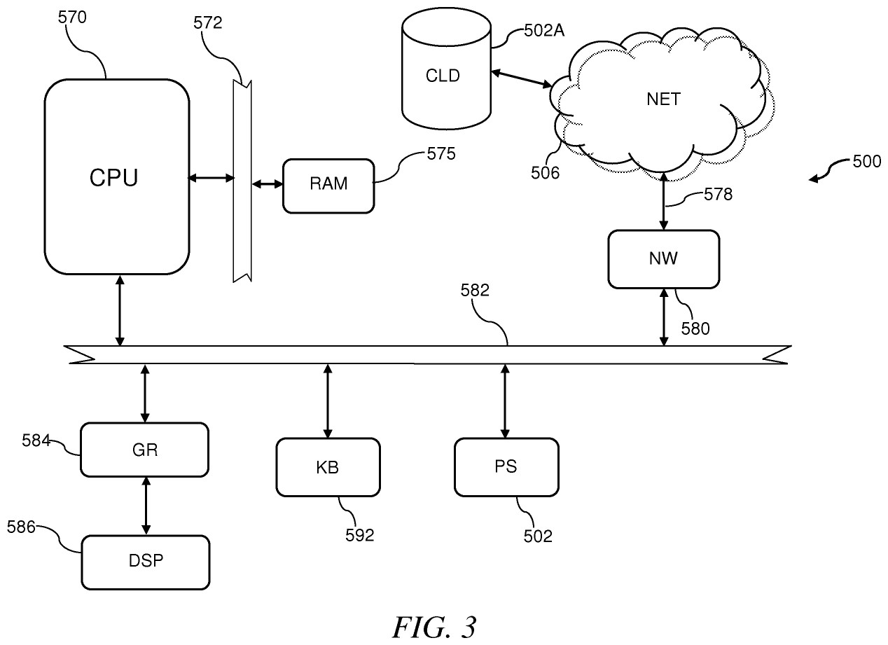

Referring to FIG. 3, a schematic view of a typical computer system (e.g., server computer 500) is shown. The example server computer 500 represents a typical computer system used for back-end processing, generating reports, displaying data, etc. This exemplary computer system is shown in its simplest form. Different architectures are known that accomplish similar results in a similar fashion and the present invention is not limited in any way to any particular computer system architecture or implementation. In this exemplary computer system, a processor 570 executes or runs programs in a random-access memory 575. The programs are generally stored within data storage 502 (e.g., persistent memory such as a disk drive, flash drive, etc.) or cloud storage 502A and loaded into the random-access memory 575 when needed. The processor 570 is any processor, typically a processor designed for computer systems with any number of core processing elements, etc. The random-access memory 575 is connected to the processor by, for example, a memory bus 572. The random-access memory 575 is any memory suitable for connection and operation with the selected processor 570, such as SRAM, DRAM, SDRAM, RDRAM, DDR, DDR-2, etc. The data storage 502 is any type, configuration, capacity of memory suitable for persistently storing data, for example, magnetic storage, flash memory, read only memory, battery-backed memory, magnetic memory, etc. The data storage 502 (e.g., disk storage) is typically interfaced to the processor 570 through a system bus 582, or any other interface as known in the industry.

Also shown connected to the processor 570 through the system bus 582 is a network interface 580 (e.g., for connecting to a data network 506 through any known type of network access 578 (e.g., 802.11, 802,3, cellular data service such as 5G, LTE, etc.), a graphics adapter 584 and a keyboard interface 592 (e.g., Universal Serial Bus USB). The graphics adapter 584 receives commands from the processor 570 and controls what is depicted on a display 586. The keyboard interface 592 provides navigation, data entry, and selection features.

In general, some portion of the data storage 502 is used to store programs, executable code, data, data related to the various construction projects, and other data, etc.

The peripherals are examples and other devices are known in the industry such as pointing devices, touch-screen interfaces, speakers, microphones, USB interfaces, Bluetooth transceivers, Wi-Fi transceivers, image sensors, temperature sensors, etc., the details of which are not shown for brevity and clarity reasons.

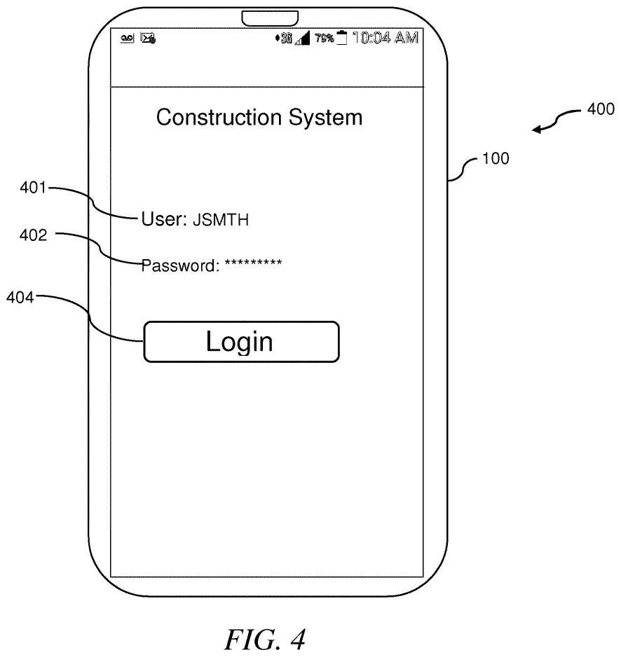

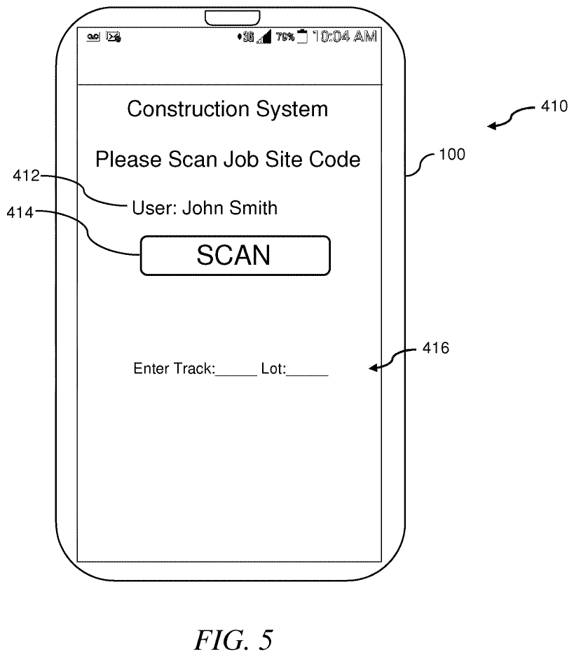

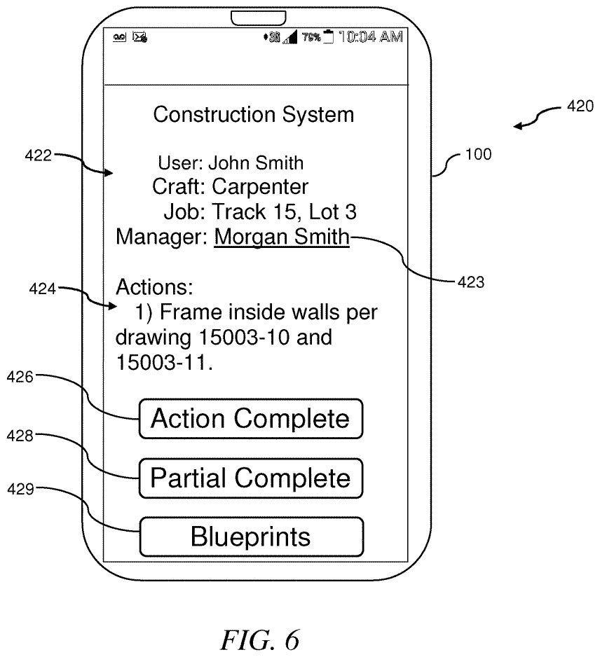

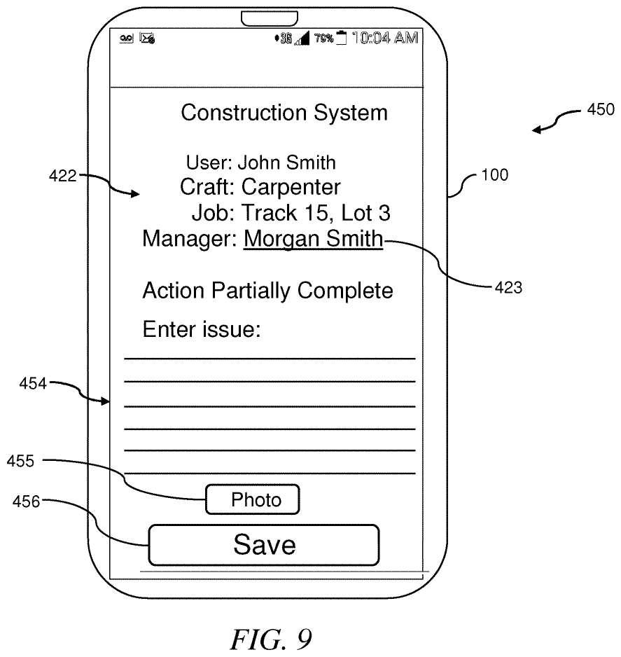

Referring to FIGS. 4-10 and 10A, smartphone user interfaces of the system for managing construction are shown. In FIG. 4, an access user interface 400 is show in which the craftsperson enters the username 401 and password 402, then selects Login 404 to access the system for managing construction. Once the correct username 401 and password 402 are entered, the scan user interface 410 is displayed. The concept here is that each job site will have a job site code 540 (e.g., a bar code, quick response code or QR code®, or any machine-readable coding often posted on a plaque 542) that is readily scanned by the craftsperson (or leader of a team of craftsmen). In FIG. 5, the name of the user 412 is displayed (e.g., the craftsman or leader of a team of craftsmen) and a scan icon 414 to initiate scanning of the job site code 540. Upon selection of the scan icon 414, the action user interface 420 of FIG. 6 is displayed. Should the scan operation fail, the craftsman or leader of a team of craftsmen could also enter an identification of the job site (e.g., by entering the track number and lot number 416.

Once the job site is determined, the action user interface 420 is displayed indicating user and location information 422 and the construction manager 423. Note that in this example, the name of the construction manager 423 is a hot link (or includes an icon that can be selected) should the user need to message or call the construction manager 423 by selecting the hot link (or icon).

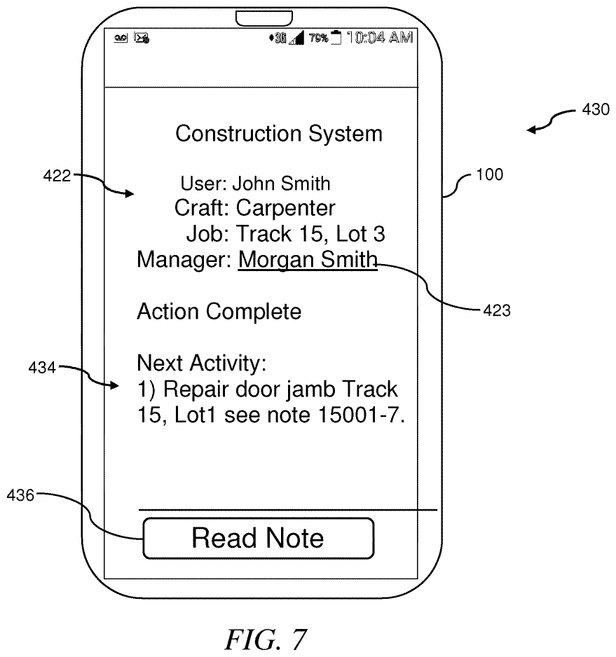

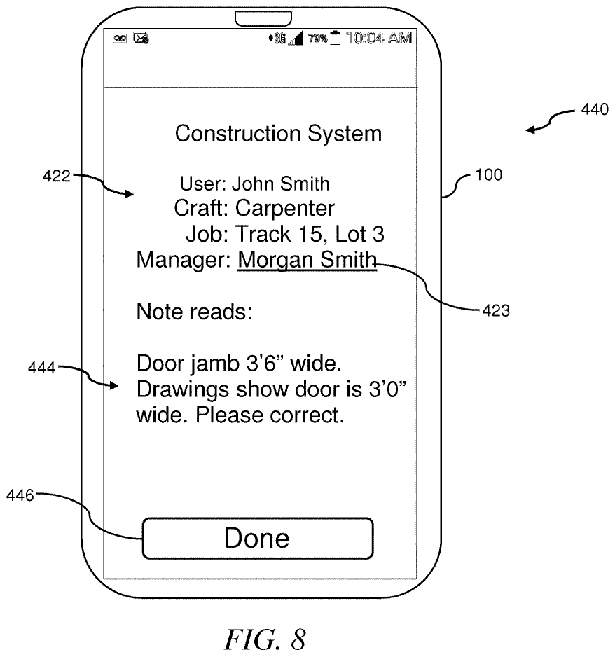

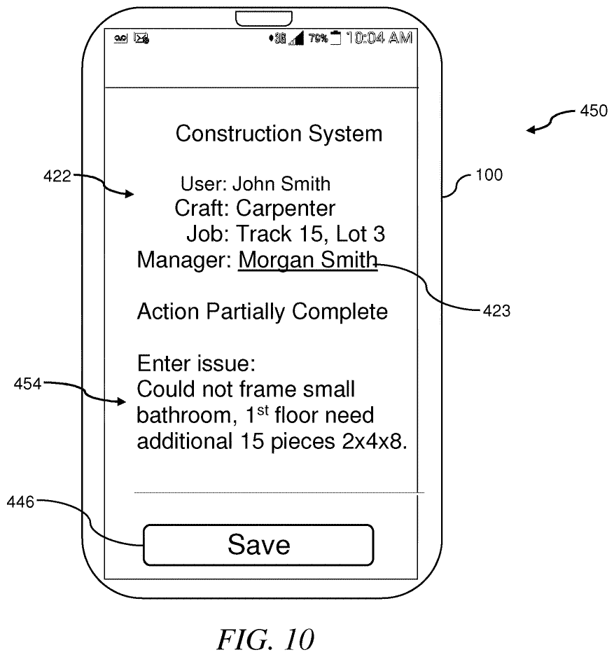

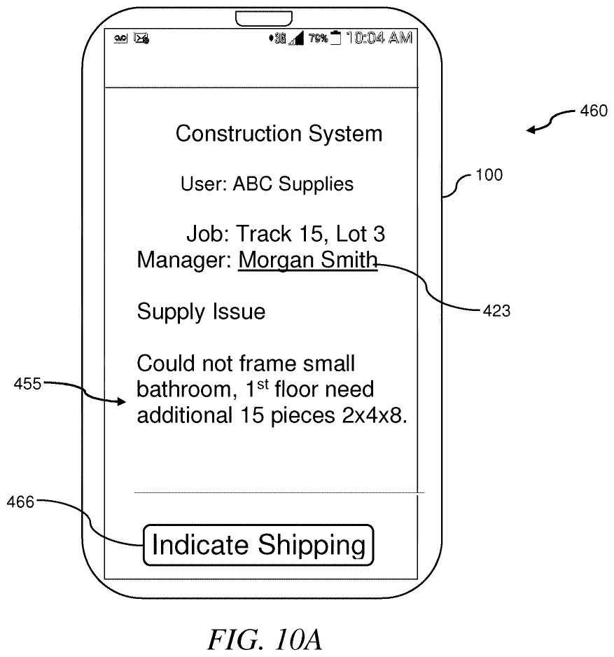

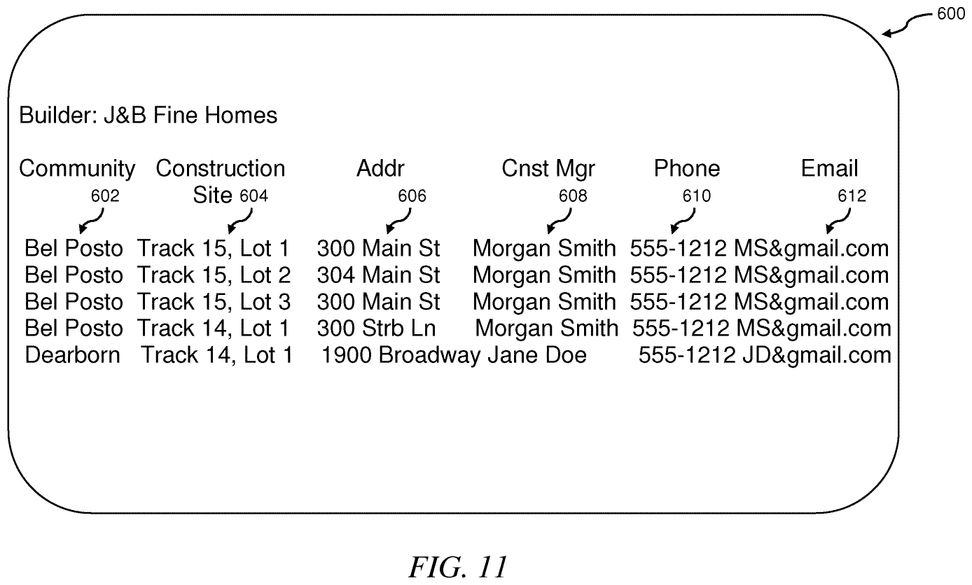

The action user interface 420 includes one or more actions 424 or tasks for the craftsman or leader of a team of craftsmen to perform, in the example of FIG. 6, the task to be completed is to frame the inside walls per a specific set of drawings. If all goes well and the craftsman or leader of a team of craftsmen completes the task (e.g., construct the interior walls), the craftsman or leader of a team of craftsmen select the action completed 426 directive to signal to the system for managing construction that this step is complete and the next task (e.g., install electrical items in the framed walls) is ready to be scheduled. In this case, the action complete user interface 430 is displayed in FIG. 7 to the craftsman or leader of a team of craftsmen indicating that the action is complete and providing the next activity 434 (or task) that needs to be performed by the craftsman or leader of a team of craftsmen. In the example of FIG. 7, the next task is to repair something from previous work that was noted by another craftsman. As the other craftsman had the ability to enter a note in the note entry field 454 (see FIG. 10), a read directive 436 is provided to read this note that was entered in the note entry field 454. Upon selecting the read directive 436, the user interface 440 of FIG. 8 is displayed showing details 444 of the rework or repair that is needed (e.g., details on why rework is required such as an opening is too wide or too narrow, etc.). When the user is finished reading the rework, a “done” directive 446 is provided to go back to the previous user interface.

In some embodiments, a “blueprint” directive 429 is provided for accessing and displaying blueprints of the construction being performed at the job site.

If the task does not go well and the craftsman or leader of a team of craftsmen cannot complete the task (e.g., construct the interior walls), the craftsman or leader of a team of craftsmen select the partial complete 428 directive (see FIG. 6) to signal to the system for managing construction that this step is not complete or could not be completed for some reason. and the next task (e.g., install electrical items in the framed walls) may need to be rescheduled. In this case, as shown in FIG. 10, the partially completed user interface 450 is displayed with a note entry field 454 into which the craftsperson enters details regarding why they could not complete the task. If a photograph helps understand the issue, there is a photo directive 455 that initiates the camera 93 to take a photo that is added to the noters. After entering text into the note entry field 454 as shown in FIG. 10 (and optionally the photograph), the save directive 456 is activated and the text is saved in the database 552. Note that in this example, the craftsperson ran out of a needed material and noted that framing of the bathroom could not be completed. Seeing this, the construction manager 423 has the opportunity to order materials (2×4s) and reschedule the craftsperson to complete the task as well as delay the next action (e.g., rough plumbing of the bathroom) until the bathroom walls are installed.

In some embodiments, when a craft or team enters an issue, the issue is parsed to determine what materials are needed as in the user interface 460 of FIG. 10A. In this example, in FIG. 10, the carpenter indicated that 15 2×4×8 are needed to finish framing the small bathroom. In FIG. 10A, the supplier (ABC Supplies) receives the message 455 telling the supplier of the parts that are missing. In this case, the materials that are needed are clear and the supplier is able to automatically ship the materials. To inform the construction manager 423 that the supplier is sending 466 the required materials, the supplier invokes a “Indicate Shipping” directive to inform all that the materials are shipping, possibly leading to another screen in which the supplier enters what is being shipped and the estimated time of arrival.

Referring to FIGS. 11, 12, and 13, exemplary data records of the system for managing construction are shown. In FIG. 11, a simplified construction site database 600 for a fictitious builder, J&B Fine Homes, is shown. In this, this builder is constructing homes in two different communities 602, Bel Posto and Dearborn. Note that it is anticipated that such a builder has many more homes being concurrently constructed and the examples shown are abbreviated for clarity reasons. Each community 602 has building being constructed (e.g., homes) as identified by a construction site 604, often listed as a track and lot number within that track. One note here is that as the number of concurrent construction projects grows, it becomes easier to confuse construction sites 604, for example, the last two construction sites 604 have the same track and lot number. This confusion sometimes leads to craftsmen visiting the wrong site, leading to inefficiencies. By using the scannable job site code 540, the craftsman determines quickly if they are at the correct construction site 604. As a second level of identification, in this example, an address 606 of the construction site 604 is also provided. For each construction site 604, the name of the construction manager 608, phone number 610, and email address 612 of the construction manager is provided.

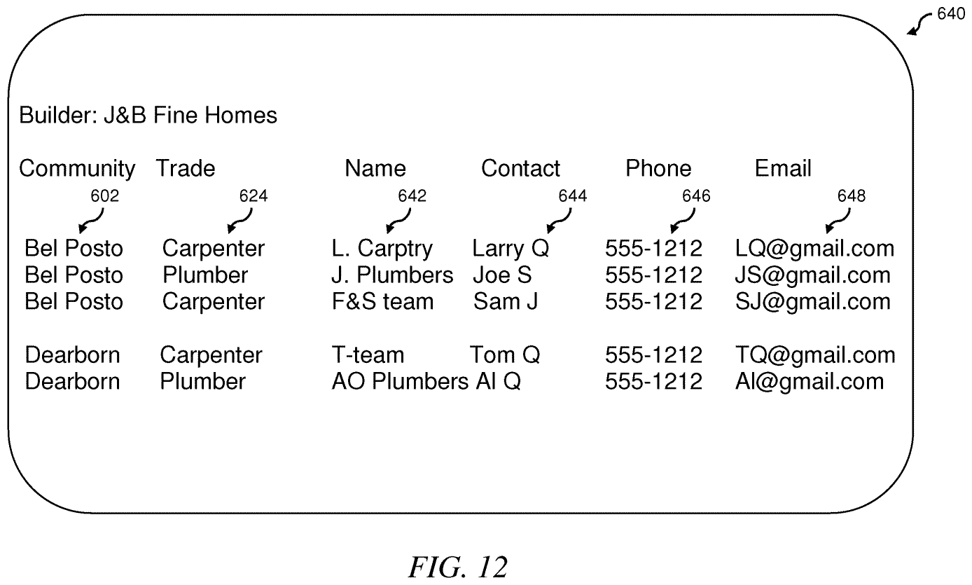

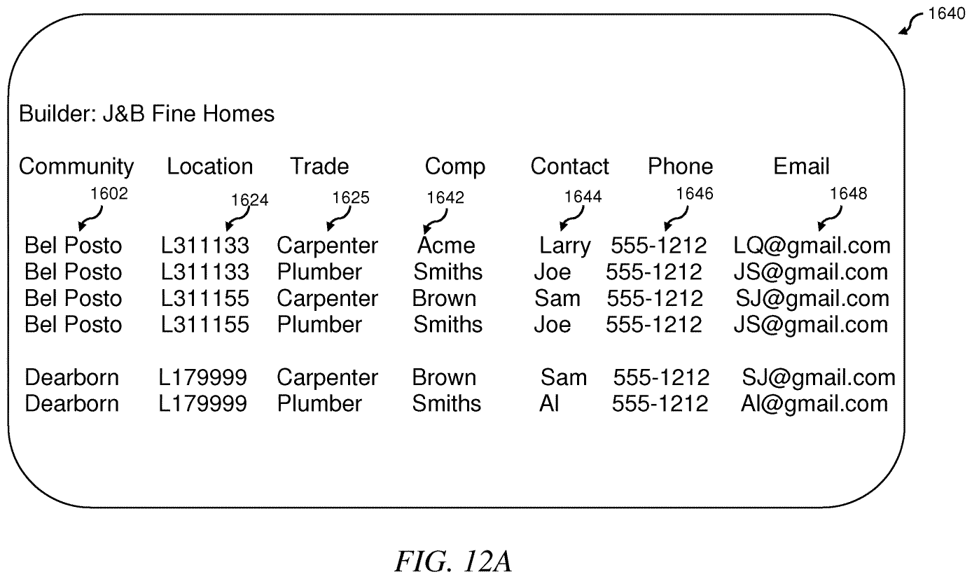

In FIG. 12, a trade database 640 is shown. In this example, as there as shown two communities 602, in some cases, the communities 602 are not local to each other and, therefore, different trade persons are needed for each community 602. Therefore, for the first community, there are available two carpenters (or teams of carpenters) and one plumber (or team of plumbers) listed under the trade 624, each having a name 642, contact person 644, phone number 646, and email address 648. A different set of trade persons or teams are listed for the second community, though in some cases, the communities 602 are close to each other and can share some or all of the trade persons or teams.

In FIG. 12A, a second trade database 1640 is shown. In this example, as above, there are two communities 1602. It is anticipated that different companies 1642 and/or contacts 1644 for each company 1642 are needed for each construction project. In the simplistic example shown, there are two communities 1602, Bel Posto and Dearborn. Each community has one or more construction projects as indicated by the location 1624 such as L311133, L311155, L179999. For each property, there is a line for each trade 1625 that is needed for that particular construction project. For brevity reasons, only two trades 1625 are shown, carpenters and plumbers. In this example, the first property, L311133, has Acme as the company 1642 for carpentry and Smiths as the company 1642 for plumbing. For Acme, there is a contact 1644 named Larry with a phone number 1646 and email address 1648. It is anticipated that the information shown in FIG. 12A is entered as the projects are added including the contact information with more or less information as needed so that when there is an issue (e.g., an issue with a window opening being too small), the associated contact 1644 can be directly and immediately notified (e.g., a text message to Larry at 555-1212). Note that the company 1642, contact names 1644, phone numbers 1646, email addresses 1648 are abbreviated for clarity and brevity reasons. It is fully anticipated that full names, complete phone numbers are included in the database.

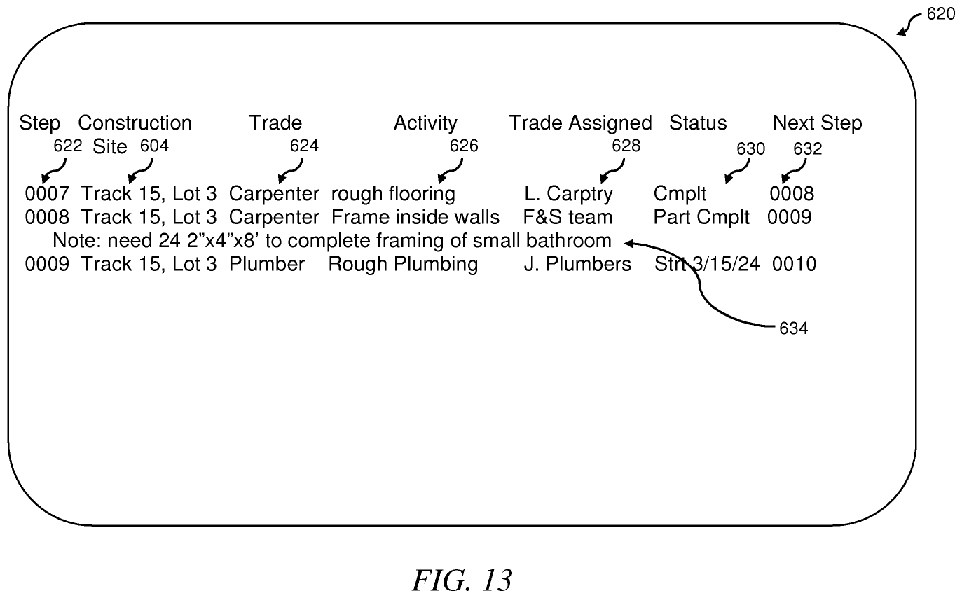

In FIG. 13, an activity database 620 or file is shown. Every construction project is divided into activities. For example, activities such as framing, rough wiring, inspection the wiring, plumbing, inspection of plumbing, drywall installation, painting, trim, etc. Further, there are often dependencies. For example, electrical and some plumbing cannot be installed before framing and drywall cannot be installed before electrical and plumbing is completed and inspected. In some cases, multiple activities are not dependent upon each other and can be performed in parallel, for example, installation of attic insulation is able to be performed while drywall is being installed elsewhere at the construction site 604. The activity database 620 (again, shown greatly abbreviated for clarity reasons) includes the construction site 604. For clarity, each activity (only three activities are shown for clarity reasons) to identify where the step must be performed. Each step has a step number 622 for an abbreviated way of referring to the step and an activity description 626 indicating what must be done in this activity. Note that it is fully anticipated that the activity includes full details of what must be done such as a description in words, images, voice, and reference to drawings or blueprints of the construction site 604 (e.g., frame small bathroom, first floor-see drawing-rl22.01.05.24). For each activity, a trade 624 is listed, for example carpenter, as the type of construction worker that is trained to perform this activity. In this example, the trade assigned 628 listed for each activity has a name of the craftsperson or name of a team of craftspeople that are assigned to each activity. It is assumed that an administrator (e.g., the construction manager 608) populates the activity database 620 with the trade assigned 628 of each activity at the beginning of each construction project or at least before the activity 626 needs be performed. The status 630 of each activity 626 is included (e.g., complete, partially complete, due to start). A next step 632 shows the activity 626 that is to be performed next. When an activity 626 cannot be completed, the trade assigned 628 enters a note into the note entry field 454 (see FIG. 10) providing details as to why the activity 626 was not completed. In one activity 626, there is a note 634 indicating that framing of a small bathroom was not finished because there were insufficient materials. This is a signal to the construction manager 608 to order the materials, schedule a trade (e.g., carpenters) to complete the activity 626, and possibly defer further tasks, as in this example, the next task is installation of rough plumbing that cannot be started until the walls of the small bathroom are completed. Therefore, the construction manager needs to reassign the trade assigned 628 (e.g., J. Plumbers) to a different project.

In summary, the activity database 620 is anticipated to be prepopulated or manually populated (e.g., by an administrator or construction manager 608) with activities 626 or tasks that must be completed for construction of each construction project, then, as the construction project proceeds, the construction manager 608 monitors progress of the activities 626 or tasks by use of the activity database 620, relying less on phone calls, text messages, and email communications to determine the status of the activities 626, alternate actions that need to be taken, trade assignments, and performance of the various trade persons or teams.

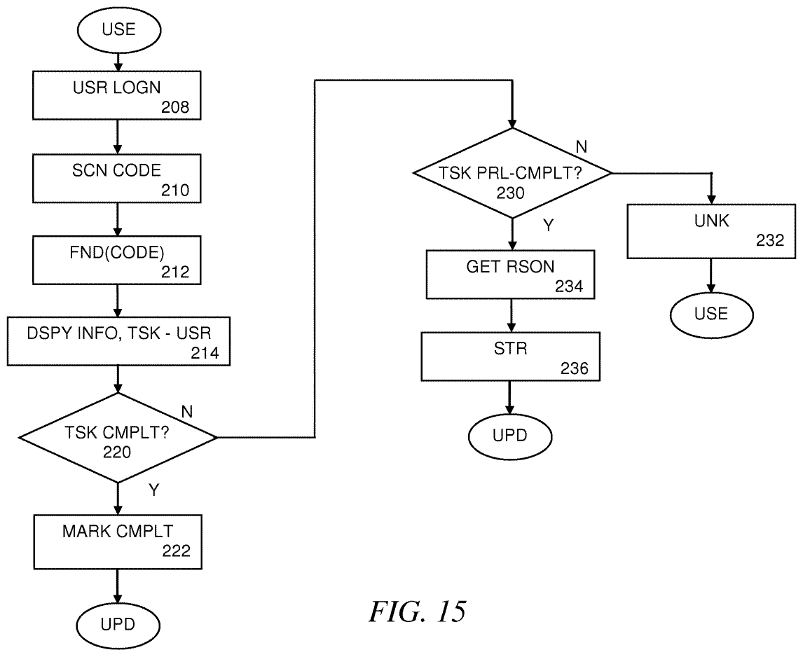

Referring to FIGS. 13, 14, 15, 16 and 17, exemplary program flows of the system for managing construction are shown. The system for managing construction includes a construction management application that runs on a user's smartphone 100 (e.g., smartphone). The smartphone 100 has a camera 93 (see FIG. 2) and the construction management application uses the camera 93 to read (or scan) the job site code 540 upon arrival at a particular construction site 604. The job site code 540 being scanned is valuable for many reasons. First, positive assurance is provided that the craftsperson or team is at the correct construction site 604, not requiring a note from the construction manager 608. Second, upon arrival at the construction site 604, the construction management application provides up-to-date information regarding the activity 626 to be performed and the status and issues regarding the prior activity 626 that was performed.

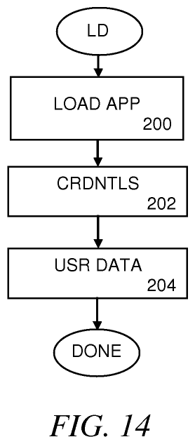

To get started, as in FIG. 14, the user (e.g., trade person or construction manager 608) loads 200 the construction management application onto their smartphone 100 (e.g., smartphone). Once the construction management application is loaded 200, the user enters credentials 202 (e.g., username and password, fingerprint) and user data 204 such as name, company, phone number, email address, home address, etc. Once entered, the construction management application is ready for use.

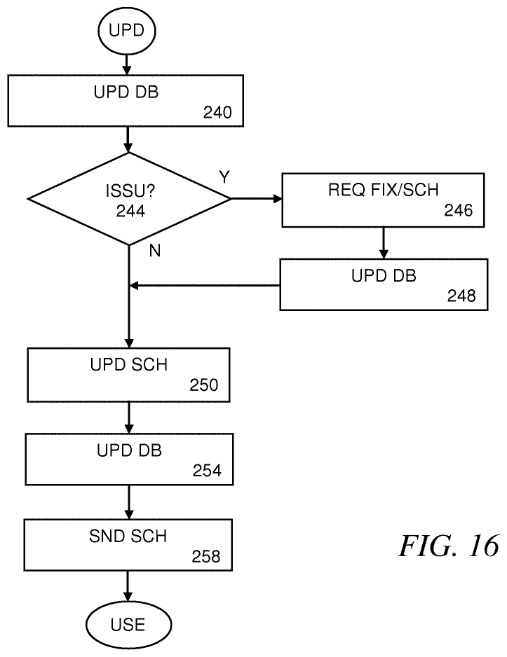

In FIG. 14, it is assumed that the user (e.g., craftsperson) is not already logged into the construction management application and the user logs in 208 (e.g., presents username and password, etc.). Now, upon arrival at the construction site 604, the user locates the plaque 542 containing the job site code 540 and, using the construction management application, scans 210 the job site code 540 to determine the construction site 604. The construction management application accesses the activity database 620 and finds 212 the activities for this construction site 604 and displays 214 the activity(s) for this construction site 604 and for this user. The user performs the activity(s) required and enters a completion status when done. If the completion status 220 is “complete,” the construction management application marks 222 the activity database 620 to indicate the completion status and updates 240 (see FIG. 16) the activity database 620 with the completion status.

If the completion status 220 is “partial,” the construction management application requests a reason 234 (e.g., by way of a note entered in the note entry field 454) and saves the note 236. The construction management application updates 240 the activity database 620 to indicate the partial completion status, including the note (see FIG. 16).

If an unknown status is provided 230, an error action 232 is taken.

As per FIG. 16, once the activity database 620 is updated 240, if there is an issue 244, a craftsperson or team is scheduled 246 to fix the issue (e.g., automatically or by the construction manager 608). In some operations, there is a specific craftsperson or team that manages rework or fixing problems. Again, the activity database 620 is updated 248 to indicate how the rework or fix is to be done and the craftsperson or team that is assigned.

The schedule is updated 250, for example, the craftsperson or team that completed the activity is assigned to a new activity and, any other activities that depend upon the completed activity are updated to mark as ready when a craftsperson or team is ready to perform the new activity. The activity database 620 is updated 254 and the schedule is sent 258 to all craftsperson or teams that are effected, for example, displayed by the construction management application for the user to know where they will go next to perform the next activity for that user.

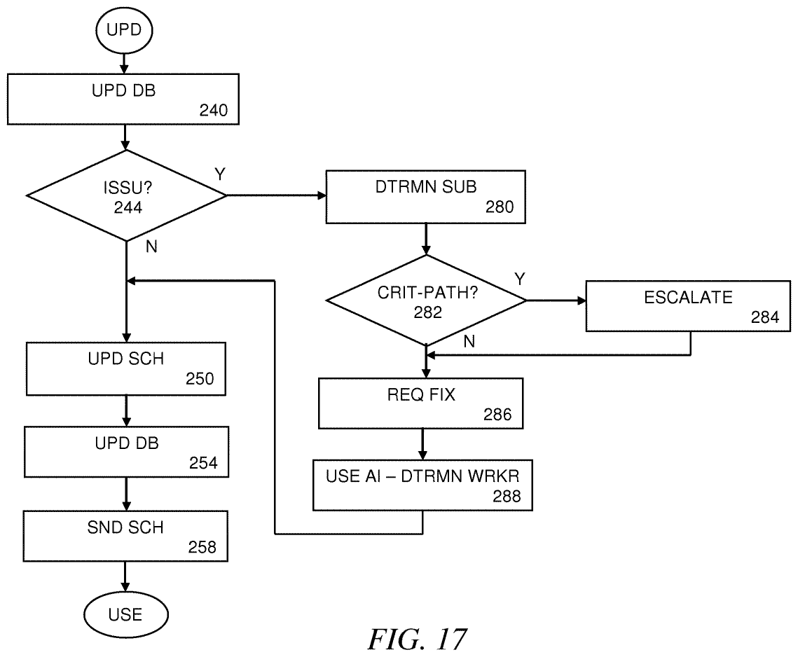

In some embodiments, as shown in FIG. 17, once the activity database 620 is updated 240, if there is an issue 244, a craftsperson or team is first determined 280 based upon the location and the craft/trade that performed the work that needs to be fixed. If the repair is in the critical path 282 (e.g., blocking other crafts from completing their work), the repair is escalated 284, possibly contacting management at the craft/trade that performed the work. In any case, the rework is requested 286 to fix the issue (e.g., automatically or by the construction manager 608). In some operations, there is a specific craftsperson or team that manages rework or fixing problems. Again, the activity database 620 is updated 248 to indicate how the rework or fix is to be done and the craftsperson or team that is assigned. In some embodiments, artificial intelligence 288 is used to determine the worker that performed the work that needed rework, to perform tasks that will lead to reducing the chances of similar problems in the future.

The schedule is updated 250, for example, the craftsperson or team that completed the activity is assigned to a new activity and any other activities that depend upon the completed activity are updated to mark as ready when a craftsperson or team is ready to perform the new activity. The activity database 620 is updated 254 and the schedule is sent 258 to all craftsperson or teams that are effected, for example, by the construction management application for the user to know where they will go next to perform the next activity for that user.

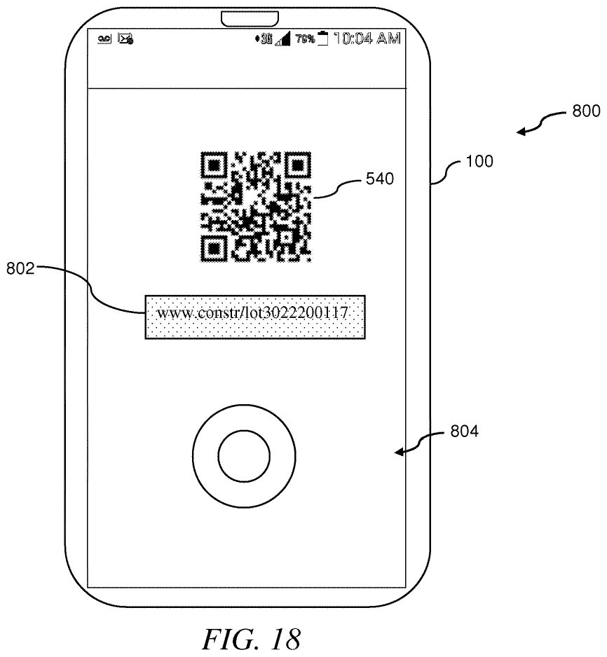

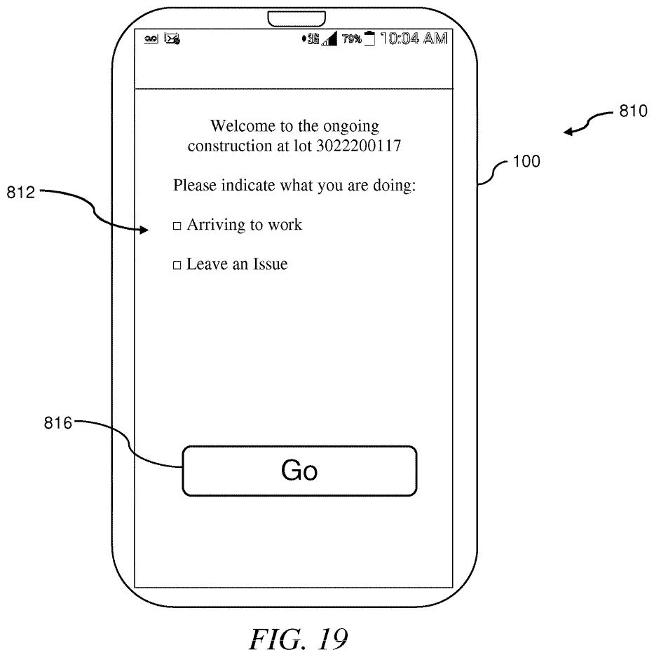

Referring to FIGS. 18, 19, 20, 20A, 21, 22, and 23, smartphone user interfaces of a second embodiment of the system for managing construction are shown. In this embodiment, the worker has a device (e.g., a smartphone 100), but there is no dedicated application running on the smartphone 100. Instead, when the worker arrives or wants to indicate that there is an issue (e.g., problem with prior work, missing materials), the worker scans the job site code 540 as in FIG. 18 (using the camera interface 800 of the smartphone shown with a shutter button 804) and, as occurs with smartphones 100 when a QR code is scanned, a link 802 to an web-based application is presented that the worker selects to initiate the user interfaces of FIGS. 19, 20, 20A, 21, 22, and 23.

In FIG. 19, an initial user interface 810 is presented on the smartphone 100, including the property or construction lot number and a selection of actions 812 that the worker will select. In this example, the actions that are presented are “Arrive at Work” and “Leave an Issue.” The first choice, “Arrive at Work,” is used when the worker first arrives to inform the worker of activities that need be performed. The second choice, “Leave an Issue,” is used when the worker discovers that there is an issue with prior work or materials. Once the worker selects either choice, the worker selects the “Go” feature 816.

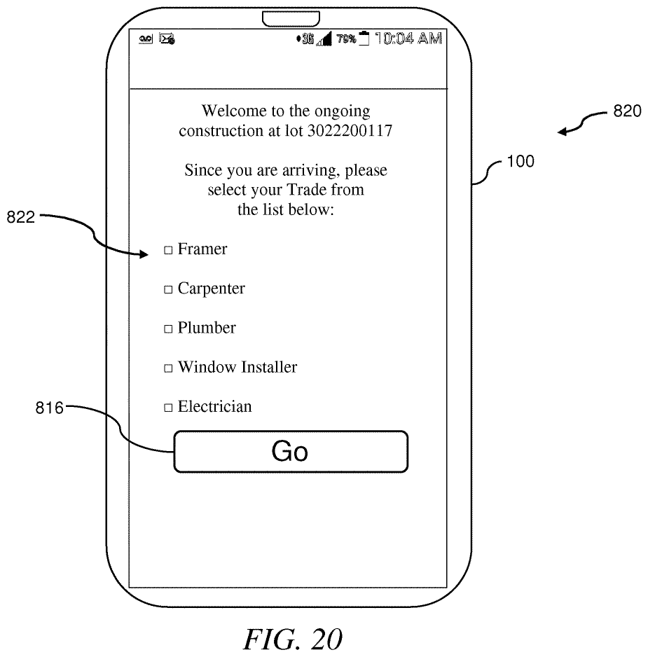

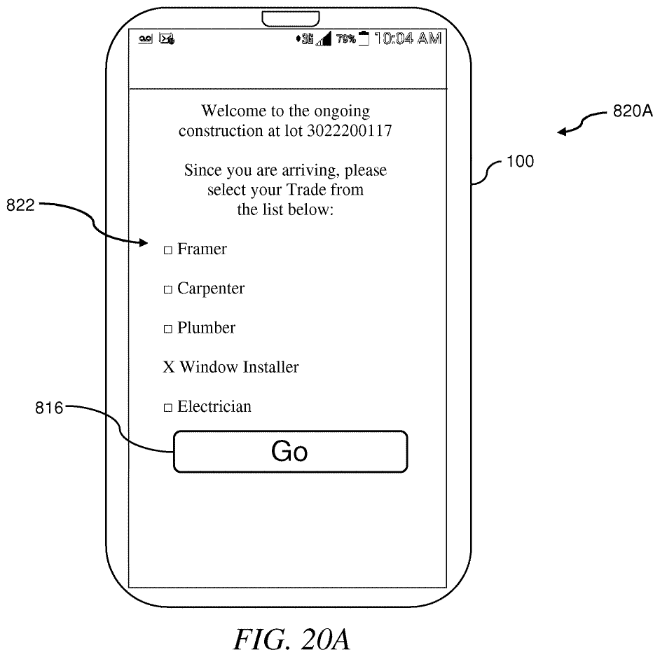

In FIGS. 20 and 20A, the worker has selected the first choice, “Arrive at Work,” and is presented with a second arrival user interface 820 which provides selections 822 for what the worker is there to do such as framing, carpentry, plumbing, window installation, electrical, etc. In FIG. 20A, the worker has selected that they are a window installer and upon selecting the “Go” feature 816, the Window Installer user interface 830 is displayed. The completed arrival interface 820A is shown in FIG. 20A.

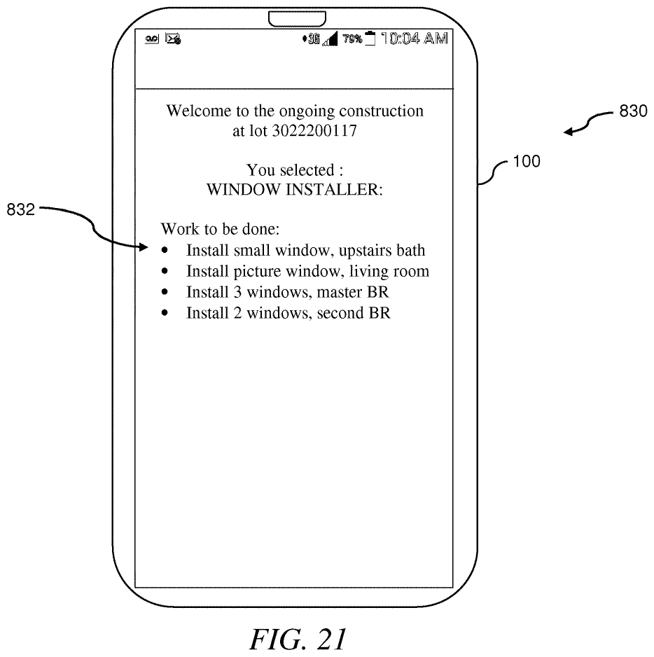

In FIG. 21, the selected that they are a window installer and upon selecting the “Go” feature 816, the Window Installer user interface 830 has a list 832 of activities that are required of the window installer. This list 832 is to guide the window installer to perform what is most needed for this particular property.

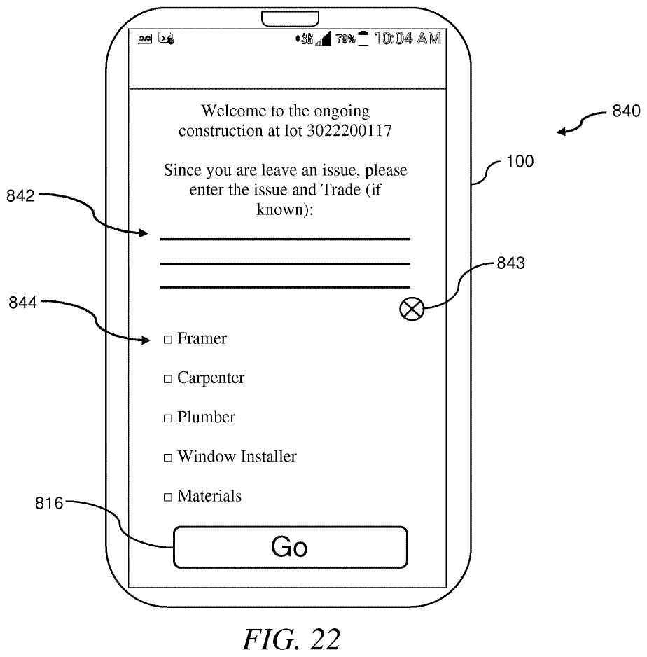

In FIG. 22, the worker has selected the second choice, “Leave an Issue,” and is presented with a leave-an-issue user interface 840. In the leave-an-issue user interface 840, there is a issue field 842 into which the worker can type a message regarding the issue. In some embodiments, the worker selects a microphone icon 843 and uses voice input (speech recognition) to enter the message regarding the issue.

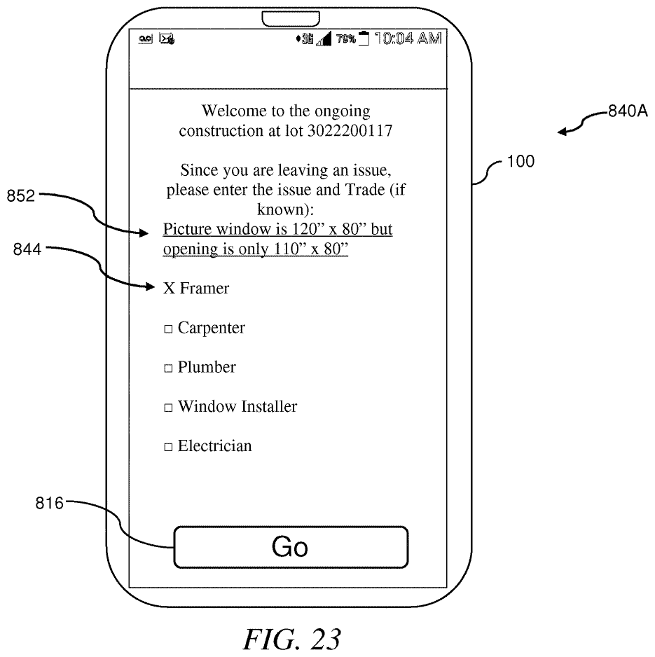

In some embodiments, the leave-an-issue user interface 840 includes craft selections for the worker to indicate which craft the worker thinks will be needed to fix the issue, for example, if the issue is not enough 2½″ nails, the worker selects “materials.” A sample completed leave-an-issue user interface 840A is shown in FIG. 23.

In FIG. 23, the worker was presented with the leave-an-issue user interface 840 and has modified the leave-an-issue user interface 840 with inputs as in the modified leave-an-issue user interface 840A. In the modified leave-an-issue user interface 850, the issue field 842 has a message 852 regarding the issue. In this example, the worker has selected “Framer” with a selection mark 844 indicating that the worker believes the framer needs to fix the issue.

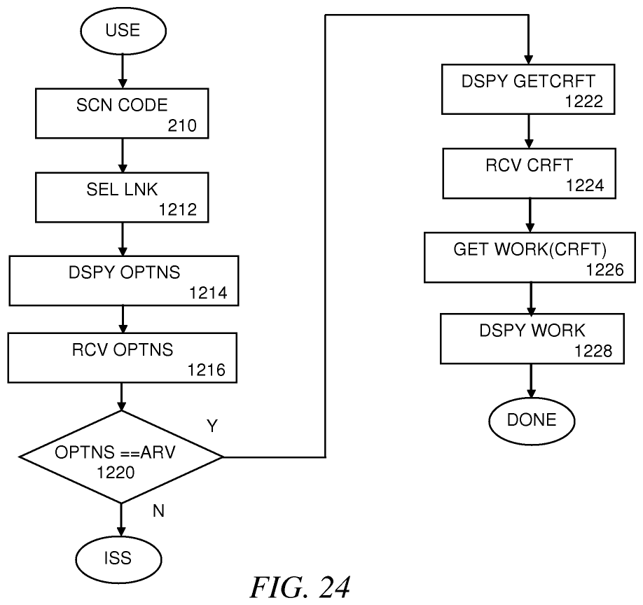

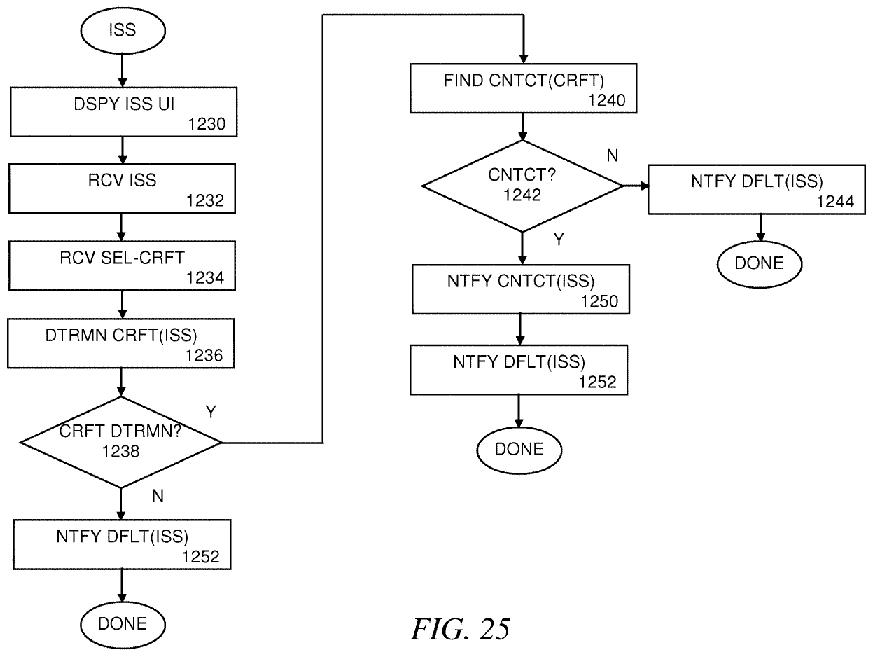

Referring to FIGS. 24 and 25, exemplary program flows of the second embodiment of the system for managing construction are shown. The system for managing construction utilizes the worker's user's smartphone 100. The smartphone 100 has a camera 93 (see FIG. 2) and a camera application as is known in the industry. The camera application uses the camera 93 to read (or scan) the job site code 540 at a particular construction site 604. The job site code 540 being scanned is valuable for many reasons. First, positive assurance is provided that the craftsperson or team is at the correct construction site 604. Second, upon arrival at the construction site 604, up-to-date information regarding the activities that are to be performed is provided. Third, when there is an issue, user interfaces for the worker to describe the issue are provided.

The worker at the construction site 604 locates the plaque 542 containing the job site code 540 and, using the camera application of the smartphone 100, the worker scans 210 the job site code 540 which has embedded therein the construction site 604. The construction worker will see a link to the server computer 500 and selects 1212 the link. This opens a browser application on the worker's smartphone 100 and the server causes the browser to display an options screen 1214 (similar to FIG. 19). The worker uses the options screen to indicate whether they are arriving at the construction site or leaving an issue. This option is received 1216 and when the option is arrival 1220, the server causes the browser to display a craft selection screen 1222 and the worker selects which craft they are (e.g., “framer”). After the craft is received 1224, a look-up is performed 1226 from a database populated with tasks for each craft at each particular job site to obtain a list of activities for that particular craft at that particular job site and the server causes the browser to display 1228 the work (e.g., list of activities) for that particular job site.

When the option is leave an issue 1220, program flow proceeds with FIG. 25. The server causes the browser to display an issue screen 1230 and the worker enters an issue (e.g., a message describing a particular problem such as missing or lack of materials, problem caused by a different craft). After the issue is received 1232 and optionally a selected craft 1234 (e.g., the worker indicated which craft needs to respond to the issue), the craft responsible for the issue is determined 1236.

As the issue is entered by the worker in free-format, the text of the issue is not always clear. For example, for some workers, their primary language is not English or for some, grammar, spelling, and punctuation are not always the best. Therefore, the step of determining 1236 the craft responsible for the issue is often not a simple lookup. Instead, the issue is analyzed using artificial intelligence to determine 1236 the craft that is responsible for the issue. By using artificial intelligence, the text of the issue is understood, even when there are missing words (e.g., “opning 2 small”) or abbreviations (e.g., “opning should b 40 but is 37”). The step of determining 1236 also consults the activities that the worker has been doing to further understand the issue and, using learned history, the step of determining 1236 understands better by what was entered in the past. The step of determining 1236 produces a probable craft and, in some embodiments, a certainty factor (e.g., 85% sure that the craft is “framer”).

When the craft is not determined 1238 (or at least with an acceptable certainty factor), a default person is notified 1252, for example, a supervisor or construction manager responsible for that particular job site. The notification will include the issue that was received and, in some embodiments, the craft that was determined with little certainty. The default person will try and determine the issue and required craft and, in some embodiments, provide feedback to the step of determining 1236 to teach the step of determining 1236 how to better understand such issue messages. All issues and corrections are added to the knowledgebase 553 to improve understanding of future issues by way of artificial intelligence.

When the craft is determined 1238, a contact for the craft is found 1240, for example, using the table of FIG. 12A. When a contact cannot be found 1242 (e.g., a contact for a particular craft was never established), a default person is notified 1244, for example, a supervisor or construction manager responsible for that particular job site. The notification will include the issue that was received. In some embodiments, the default person will be informed that no contact is assigned for this particular craft so that a person can be assigned.

When a contact is found 1242 (e.g., a contact for a particular craft is found in the table/database of FIG. 12A), the contact is notified 1250. The notification will include the issue that was received, and a best interpretation made by the step of determining 1236 the craft. For example, if the issue as entered was “opning should b 40 but is 37” and the step of determining 1236 the craft understood the issue to be “the opening should be 40 inches but was 37 inches instead,” then the more readable message is sent in the notification, possible followed by the original text as well.

It should be noted that all notification are made by any text or voice messaging service as known in the industry, including, but not limited to text messages, email messages, voice messages, social networking messages (e.g. “Whatsapp”), etc.

In some embodiments, a default person is notified 1252, for example, a supervisor or construction manager responsible for that particular job site. The notification will include the issue that was received. In some embodiments, the default person will be informed that no contact is assigned for this particular craft so that a person can be assigned.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction, and arrangement of the components thereof without departing from the scope and spirit of the invention or without sacrificing all of its material advantages. The form herein before described being merely exemplary and explanatory embodiment thereof. It is the intention of the following claims to encompass and include such changes.

1. A system for managing construction at a job site the system comprising:
a server computer, the server computer having a storage and a database installed within the storage, the database populated with user data and activity data related to the construction at the job site and including contact mapping data that associates the jobsite and particular crafts to a contact for that particular craft at the jobsite including a phone number and/or email address of each contact;
a smartphone of a worker, the smartphone having a processor, a display, means for data entry, local storage, and means for communicating with the server computer, a camera application runs on the processor of the smartphone;
a job site code for the job site encoded into a scannable medium, the scannable medium installed at a construction site;
after the camera application captures the job site code, the camera application initializes a browser application to run on the smartphone and the browser application connects with the server computer providing the job site code to the server computer;
the server computer sends a first user interface to the browser application and the browser application displays the first user interface on the display of the smartphone, the first user interface comprises selections for a craft of the worker;
the server computer receives the selection for the craft of the worker from the browser application;
the server computer sends a second user interface using the browser application and the browser application displays the second user interface on the display of the smartphone, the second user interface includes selections for when the worker is arriving at the job site or when the worker needs to report an issue;
upon receiving a response from the browser application, when the response indicates arriving at the job site, the server computer retrieves a set of activities for the craft at the job site from the database and sends the set of activities to the browser application and the browser application displays the set of activities on the display of the smartphone;
when the response indicates that the worker needs to report the issue, a third user interface is sent to the browser application and upon receiving the third user interface, the third user interface is displayed on the display of the smartphone, the third user interface provides input areas for the worker to describe the issue;
after the worker describes the issue, the browser application sends the issue to the server computer for analysis; and
upon receiving the issue, the server computer determines a responsible craft for the issue and the server computer looks up the responsible craft in the database to determine a contact for the responsible craft and the server computer immediately transmits the issue to the contact for the responsible craft.

2. The system of claim 1, wherein the job site code is a quick response code.

3. The system of claim 1, wherein the third user interface comprises an input for the worker to indicate a proposed craft and upon receiving the issue and the proposed craft, the server computer determines the responsible craft for the issue from the proposed craft and/or the issue and the server computer looks up the responsible craft in the database to determine the contact for the responsible craft and the server computer immediately transmits the issue to the contact for the responsible craft.

4. The system of claim 1, whereas the server computer determines the responsible craft using artificial intelligence.

5. The system of claim 4, whereas when the server computer fails to determine the responsible craft, the server computer immediately transmits the issue to a manager for the job site.

6. The system of claim 5, whereas when the manager determines a responsible craft, the manager sends the responsible craft to the server computer, the server computer provides feedback to the artificial intelligence, and the server computer looks up the responsible craft in the database to determine the contact for the responsible craft and the server computer immediately transmits the issue to the contact for the responsible craft.

7. A method for managing construction at a job site, the method comprising:
providing a database installed within a storage, populating the database populated with contacts and activity data related to the construction at the job site;
providing a job site code encoded into a scannable medium and installed at the job site;
a worker capturing the job site code using a camera application of a smartphone;
initializing a browser application to run on the smartphone and the browser application connecting with a server computer, providing the job site code to the server computer;
the server computer sending a first user interface to the browser application and the browser application displaying the first user interface on a display of the smartphone, the first user interface comprising selections for a craft of the worker;
the server computer receiving the selection for the craft of the worker from the browser application;
the server computer sending a second user interface using the browser application and the browser application displaying the second user interface on the display of the smartphone, the second user interface includes selections for when the worker is arriving at the job site or when the worker needs to report an issue;
receiving a response from the browser application, when the response indicates arriving at the job site, the server computer retrieving a set of activities for the craft at the job site from the database and the server computer sending the set of activities to the browser application and the browser application displaying the set of activities on the display of the smartphone;
when the response indicates that the worker needs to report the issue, the server computer sending a third user interface to the browser application and upon receiving the third user interface, displaying the third user interface on the display of the smartphone, the third user interface providing input areas for the worker to describe the issue;
the worker describing the issue, the browser application sending the issue to the server computer for analysis; and
upon receiving the issue, the server computer determining a responsible craft for the issue and the server computer looking up the responsible craft in the database to determine a contact for the responsible craft and the server computer immediately transmitting the issue to the contact for the responsible craft.

8. The method of claim 7, wherein the job site code is a quick response code.

9. The method of claim 8, wherein the job site code is displayed on a plaque at a job site.

10. The method of claim 7, whereas the determining by the server computer is performed using artificial intelligence.

11. The method of claim 10, whereas when the server computer failing to determine the responsible craft, the server computer immediately transmitting the issue to a manager for the job site.

12. The method of claim 11, whereas when the manager has determined a responsible craft, the manager sending the responsible craft to the server computer, the server computer providing feedback to the artificial intelligence, and the server computer looking up the responsible craft in the database to determine the contact for the responsible craft and the server computer immediately transmitting the issue to the contact for the responsible craft.

13. Program instructions tangibly embodied in a non-transitory storage medium comprising at least one instruction configured to implement a system for construction management, wherein the at least one instruction comprises:
computer readable instructions executed by a first processor of a user device causing the user device to scan a job site code, the job site code associated with a construction site, the user device having means for displaying and means for inputting from a user;
responsive to the computer readable instructions executed by the first processor of the user device receiving the job site code, the computer readable instructions executed by the first processor of the user device causing the user device to send a transaction to a server computer, the server computer having a second processor and access to a database of activities and contacts, the transaction comprising the job site code;
responsive to the computer readable instructions executed by the second processor of the server computer receiving the transaction, the computer readable instructions executed by the second processor transmitting a first user interface to the browser application and the computer readable instructions executed by the first processor displaying the first user interface on a display of the smartphone, the first user interface comprising selections for a craft of the worker;
the computer readable instructions executed by the first processor of the user device receiving a selection of the craft of the worked and sending the craft to the computer readable instructions of the second processor;
the computer readable instructions executed by the second processor causing the user device to display a second user interface on the display of the smartphone, the second user interface includes selections for when the worker is arriving at the job site or when the worker needs to report an issue;
receiving a response, when the response indicates arriving at the job site, the computer readable instructions executed by the second processor retrieving a set of activities for the craft at the job site from the database and the computer readable instructions executed by the second processor sending the set of activities to smartphone and the computer readable instructions executed by the first processor displaying the set of activities on the display of the smartphone;
when the response indicates that the worker needs to report the issue, the computer readable instructions executed by the second processor sending a third user interface to the smartphone and upon receiving the third user interface, the computer readable instructions executed by the first processor displaying the third user interface on the display of the smartphone, the third user interface providing input areas for the worker to describe the issue;
after the worker describing the issue, the computer readable instructions executed by the first processor sending the issue to the computer readable instructions executed by the second processor for analysis; and
upon receiving the issue, the computer readable instructions executed by the second processor determining a responsible craft for the issue and the computer readable instructions executed by the second processor looking up the responsible craft in the database to determine a contact for the responsible craft and the computer readable instructions executed by the second processor immediately transmitting the issue to the contact for the responsible craft.

14. The program instructions tangibly embodied in the non-transitory storage medium of claim 13, wherein the job site code is a quick response code.

15. The program instructions tangibly embodied in the non-transitory storage medium of claim 14, wherein the job site code is displayed on a plaque at a job site.

16. The program instructions tangibly embodied in the non-transitory storage medium of claim 13, whereas the computer readable instructions executed by the second processor performing the determining using artificial intelligence.

17. The program instructions tangibly embodied in the non-transitory storage medium of claim 16, whereas when failing to determine the responsible craft by the computer readable instructions executed by the second processor, the computer readable instructions executed by the second processor immediately transmitting the issue to a manager for the job site.

18. The program instructions tangibly embodied in the non-transitory storage medium of claim 17, whereas when the manager has determined a responsible craft, the manager sending the responsible craft to the computer readable instructions executed by the second processor, responsive to receiving the responsible craft, the computer readable instructions executed by the second processor providing feedback to the artificial intelligence, and the computer readable instructions executed by the second processor looking up the responsible craft in the database to determine the contact for the responsible craft and the computer readable instructions executed by the second processor immediately transmitting the issue to the contact for the responsible craft.
